(19) United States
(12) Patent Application Publication
(10) Pub. No.: US 2017/0284254 A1
(43) Pub. Date: Oct. 5, 2017

(54) DRIP-IRRIGATION CATALYTIC REDUCTION EXHAUST PIPE

(71) Applicant: Wen-Lo Chen, Taipei City (TW)

(72) Inventor: Wen-Lo Chen, Taipei City (TW)

(21) Appl. No.: 15/083,307

(22) Filed: Mar. 29, 2016

(51) Int. Cl. F01N 3/20; F02D 41/02; F01N 3/021

(52) U.S. Cl. CPC F01N 3/2066; F01N 3/021; F02D 41/0235; F01N 2610/02; F01N 2240/05

(57) ABSTRACT

A drip-irrigation catalytic reduction exhaust pipe includes an exhaust pipe having a pipe wall in which a plurality of first apertures is formed and a plurality of direct-through ceramic filters arranged in the exhaust pipe in an axial direction from an exhaust gas inlet opening toward the exhaust gas outlet opening, or alternatively, a wall-flow filter being arranged at a location that is closest to the exhaust gas outlet opening. A flow guide tube is arranged outside the exhaust pipe and is connected to a container and includes a plurality of second apertures. The second apertures respectively correspond to the first apertures. An electromagnetic valve controls passage of urea liquid contained in the container through the second apertures and the first apertures to drip into the exhaust pipe and absorbed by a ceramic fiber material for penetration into pores of the direct-through ceramic filters and the wall-flow filter.

### TECHNICAL FIELD OF THE INVENTION

The present invention relates generally to a catalytic conversion device for use in a diesel engine exhaust pipe, and more particularly to a device that effectively and completely purifies exhaust gas emitting from a diesel engine.

### DESCRIPTION OF THE PRIOR ART

A diesel particulate filter (PDF) is commonly used to capture and collect exhaust or soot of engine combustion of a diesel automobile and filter out carbon particulates. When the quantity of carbon particulates captured reaches a predetermined level, an electronic control unit of the vehicle conducts a filter regeneration operation, which burns the carbon particulates collected in the filter to carbon dioxide that is then discharged, in order to purify the filter and restore the function of filtration.

In addition to carbon particulates, the exhaust gas of a diesel automobile also includes nitrogen oxides (NOx) that pollute the environment. Conventionally, selective catalytic reduction (SCR) is involved in processing the nitrogen oxides. A SCR system introduces urea from an urea barrel arranged in an automobile into combustion exhaust gas to convert the exhaust gas that is generally of a high temperature into ammonia (NH₃), which generates a chemical reduction reaction with nitrogen oxides (NOx) contained in the SCR to become nitrogen and water that do not severely affect the environment. In such a converting reduction operation, the ratio between diesel and urea is generally 20:1 (meaning for every 20 parts of diesel, one part of urea will be consumed) and thus, urea will be consumed very quickly.

Frequent replenishment is required in order to maintain normal operation. This makes the use of such a system very inconvenient and also consumes a large amount of money.

### SUMMARY OF THE INVENTION

An object of the present invention is to provide a solution for handling the inconvenience of use and great consumption of money for frequent replenishment of urea to maintain normal operation due to the large consumption of urea in a conventional diesel engine purification device.

The present invention provides a drip-irrigation catalytic reduction exhaust pipe, which comprises an exhaust pipe having a pipe wall in which a plurality of first apertures is formed and a plurality of direct-through ceramic filters arranged in the exhaust pipe in an axial direction from an exhaust gas inlet opening toward the exhaust gas outlet opening, or alternatively, a wall-flow filter being arranged at a location that is closest to the exhaust gas outlet opening. A flow guide tube is arranged outside the exhaust pipe and is connected to a container and comprises a plurality of second apertures. The second apertures respectively correspond to the first apertures. An electromagnetic valve is arranged to control passage of urea liquid contained in the container through the second apertures and the first apertures to drip into the exhaust pipe to be absorbed by a ceramic fiber material wrapped around outer circumferences of the direct-through ceramic filters and the wall-flow filter for penetration into pore of the direct-through ceramic filters and the wall-flow filter that serve as a catalyst so that toxicant exhaust gases, such as nitrogen oxide (NOx), when passing through the direct-through ceramic filters and the wall-flow filter are decomposed by urea or ammonia for reduction into diatomic nitrogen and water thereby reducing pollution to the environment.

A technical solution of the present invention comprises: an exhaust pipe, which comprises an exhaust gas inlet opening and an exhaust gas outlet opening respectively formed in two axial ends and in communication with each other, the exhaust pipe having a pipe wall in which a plurality of first apertures is formed; a plurality of direct-through ceramic filters, which has an outer circumference surrounded by a ceramic fiber material and is arranged in the exhaust pipe in such a way of being lined up, in an axial direction of the exhaust pipe, from the exhaust gas inlet opening towards the exhaust gas outlet opening; a wall-flow filter, which is arranged in the exhaust pipe at a location that is closest to the exhaust gas outlet opening; and a flow guide tube, which comprises a plurality of second apertures, the flow guide tube being arranged outside the pipe wall of the exhaust pipe such that the second apertures respectively correspond to the first apertures, the flow guide tube being connected to a container that receives and holds therein urea liquid, the flow guide tube being provided, at a location thereof, with an electromagnetic valve, which controls passages of the urea liquid of the container through the second apertures and the first apertures to be absorbed by the ceramic fiber material and subsequently penetrating into pores of the direct-through ceramic filters and the wall-flow filter.

In an alternative embodiment, the present invention comprises an additional direct-through ceramic filter to replace the wall-flow filter.

Preferably, the direct-through ceramic filters and the wall-flow filter of the present invention are arranged in the exhaust pipe to separate from each other.

In an embodiment, the comprises an electromagnetic valve that is electrically connected to an electrical power supply of an automobile so that when the electrical power supply of the automobile is activated, the electromagnetic valve is activated simultaneously and when the electrical power supply of the automobile is shut down, the electromagnetic valve is closed simultaneously.

Preferably, the present invention is structured such that the first apertures are arranged along a straight line in the axial direction of the exhaust pipe and the second apertures are arranged along a straight line in an axial direction of the flow guide tube.

Advantages of the present invention are as follows. With the exhaust pipe according to the present invention installed in an automobile, during the operation of the automobile, a catalyst converter that is installed in advance in the automobile may burn off carbon particulates contained in exhaust gas and the exhaust gas is guided through the direct-through ceramic filters and the wall-flow filter for removal of toxicant substances. Further, the present invention does not need frequent replenishment of urea into an engine that is generally conducted in a prior art devices and instead, the present invention supplies, in a continuous manner, a proper amount of urea liquid to the ceramic fiber material that is wrapped around the direct-through ceramic filters and the wall-flow filter such that the ceramic fiber material absorbs the urea liquid and is constantly kept wet, thereby allowing the urea liquid to penetrate into pores of the direct-through ceramic filters or the wall-flow filter. Toxicant exhaust gases, such as nitrogen oxides (NOx), when passing through the direct-through ceramic filters and the wall-flow filter, will be decomposed and reduced to diatomic nitrogen and water so as to reduce pollution to the environment.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a plan view, in a sectioned form, showing a first embodiment of the present invention.

FIG. 2 is a perspective view showing the first embodiment of the present invention.

FIG. 3 is a plan view, in a sectioned form, showing a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

### Embodiment 1

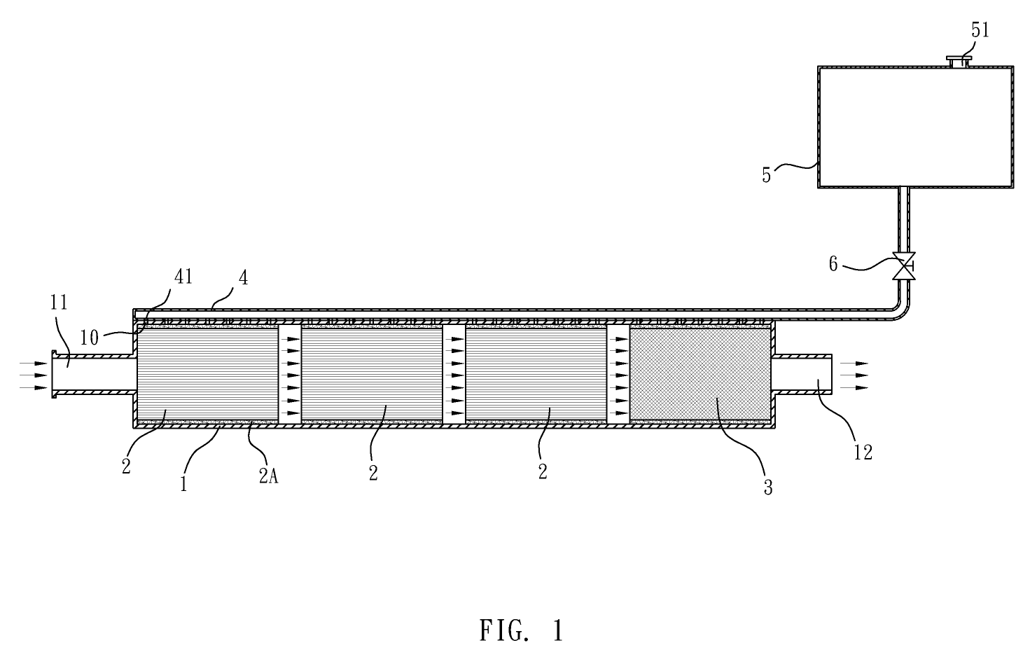

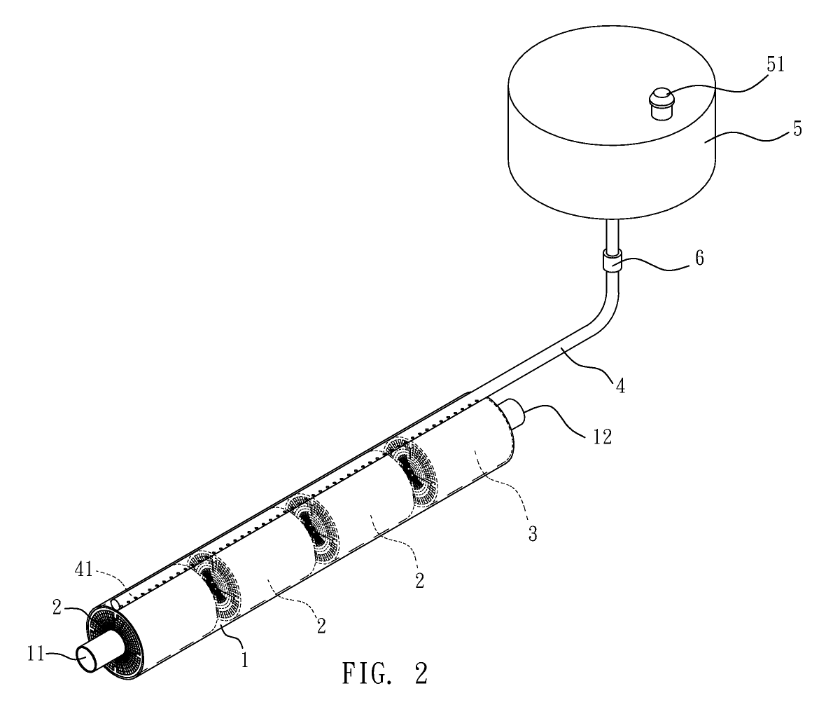

As shown in FIGS. 1 and 2, the present invention provides a drip-irrigation catalytic reduction exhaust pipe, which, as a first embodiment, comprises an exhaust pipe 1. The exhaust pipe 1 comprises an exhaust gas inlet opening 11 and an exhaust gas outlet opening 12 respectively formed in two axial ends of the pipe and in communication with each other. The exhaust pipe 1 comprises a circumferential pipe wall in which a plurality of first apertures 10 is formed and extends through the pipe wall. The first apertures 10 are arranged along a straight line in the axial direction of the exhaust pipe 1. The exhaust pipe 1 comprises a plurality of direct-through ceramic filters 2 and a wall-flow filter 3 arranged therein; and, preferably, the direct-through ceramic filters 2 and the wall-flow filter 3 are arranged to be spaced from each other in the exhaust pipe 1. Each of the direct-through ceramic filters 2 and the wall-flow filter 3 has an outer circumference that is surrounded by a liquid-absorbent ceramic fiber material 2A. The direct-through ceramic filters 2 are arranged in the exhaust pipe 1 in such a way of being lined up, in the axial direction of the exhaust pipe 1, from the exhaust gas inlet opening 11 towards the exhaust gas outlet opening 12, while the wall-flow filter 3 is arranged at a location that is closest to the exhaust gas outlet opening 12.

A flow guide tube 4 is arranged outside and along the pipe wall of the exhaust pipe 1. The flow guide tube 4 has a tubular wall in which a plurality of second apertures 41 is formed such that the second apertures 41 are arranged along a straight line in an axial direction of the flow guide tube 4. The flow guide tube 4 is arranged outside the pipe wall of the exhaust pipe 1 in such a way that the second apertures 41 are respectively in alignment with the first apertures 10 for communication with each other. Preferably, the flow guide tube 4 is mounted, by means of welding, to the outer circumference of the pipe wall of the exhaust pipe 1 and peripheries of the first apertures 10 and the second apertures 41 are properly sealed. The flow guide tube 4 is connected to a container 5 that receives and holds therein urea liquid n the container 5. The container 5 is provided, in a top thereof, with a filling opening 51 for filling and replenishment of urea liquid. The flow guide tube 4 is provided, at a suitable location thereon, with an electromagnetic valve 6 for controlling passage of the urea liquid. In the embodiment of the present invention, the electromagnetic valve 6 is electrically connected to an electrical power supply of an automobile such that when the electrical power supply of the automobile is activated, the electromagnetic valve 6 is activated simultaneously; and when the electrical power supply of the automobile is shut down, the electromagnetic valve 6 is closed simultaneously.

The direct-through ceramic filter makes use of porosity of Cordierite ceramics to capture particulate contaminants emitting from a diesel engine and each passageway of the filter has an end that is open and an opposite end that is closed such that exhaust gas is forced to pass through a porous ceramic wall. Soot particulates generally have particle sizes that are greater than the pores of the ceramic wall and would be caught and collected in the passageway. When the filter reaches an extreme of loading, the soot may be burnt off (oxidization) to resume the function of the core. This process of oxidizing the soot is referred to as “regeneration”. In order to reduce back pressure for not affecting the power of the engine, it is commonly recommended to use a ceramic filter having a capacity that is at least twice of engine displacement as a general reference.

The wall-flow filter comprises a metallic particulate trap coated with diesel oxidant catalyst (DOC), and is formed by wrapping multiple shovel-shaped metallic corrugated boards with metal filament screen that is then processed to form a metallic honeycomb filter. Within a proper temperature range, such as 200° C.-450° C., DOC may continuously generate NO₂ that flows into the particulate trap such that NO₂ and carbon particulates deposited on the metallic fibrous board continuously generate oxidization regeneration reaction within the proper temperature range (200° C.-450° C.). This process is referred to as continuous passive regeneration. The particulate trap and DOC work collaboratively to reduce carbon particulates contained in the exhaust gas.

The operation of the present invention, after being installed in an automobile, is as follows. When the automobile is stared up, the electromagnetic valve 6 is activated simultaneously to introduce a proper amount of urea liquid from the container 5, through the second apertures 41 of the flow guide tube 4 and the first apertures 10 of the exhaust pipe 1, into the ceramic fiber material 2A. The ceramic fiber material 2A, after absorbing the urea liquid, is kept in a wet condition and allows the urea liquid to continuously penetrate into each of the direct-through ceramic filters 2 and the wall-flow filter 3. During the course of movement of exhaust gas of a diesel engine that enters from the exhaust gas inlet opening 11 at one end of the exhaust pipe 1 and leaves from the exhaust gas outlet opening 12 at an opposite end, toxicant gases, such as nitrogen oxide (NOx), when flowing, in sequence, through each of the direct-through ceramic filters 2 and the wall-flow filter 3, will be decomposed and reduced by urea or ammonia into diatomic nitrogen and water so as to reduce pollution to the environment. Embodiment 2

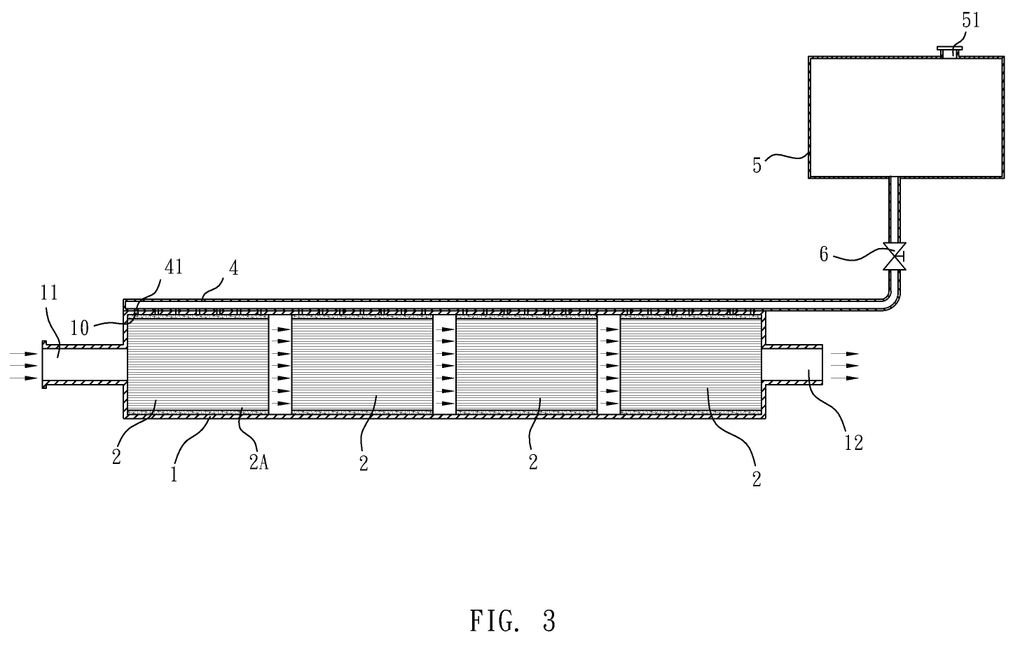

As shown in FIG. 3, a drip-irrigation catalytic reduction exhaust pipe according to a second embodiment of the present invention comprises a structure that is similar to that of the previous embodiment and a difference resides in that the exhaust pipe 1 comprises only a plurality of direct-through ceramic filters 2 that are axially arranged and no wall-flow filter is included. As such, when an automobile is stared up, the electromagnetic valve 6 is activated simultaneously to introduce a proper amount of urea liquid from the container 5, through the second apertures 41 of the flow guide tube 4 and the first apertures 10 of the exhaust pipe 1, into the ceramic fiber material 2A. The ceramic fiber material 2A, after absorbing the urea liquid, is kept in a wet condition and allows the urea liquid to continuously penetrate into each of the direct-through ceramic filters 2. During the course of movement of exhaust gas of a diesel engine that enters from the exhaust gas inlet opening 11 at one end of the exhaust pipe 1 and leaves from the exhaust gas outlet opening 12 at an opposite end, toxicant gases, such as nitrogen oxide (NOx), when flowing, in sequence, through each of the direct-through ceramic filters 2, will be decomposed and reduced by urea or ammonia into diatomic nitrogen and water so as to reduce pollution to the environment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A drip-irrigation catalytic reduction exhaust pipe, comprising:
an exhaust pipe, which comprises an exhaust gas inlet opening and an exhaust gas outlet opening respectively formed in two axial ends and in communication with each other, the exhaust pipe having a pipe wall in which a plurality of first apertures is formed;
a plurality of direct-through ceramic filters, which has an outer circumference surrounded by a ceramic fiber material and is arranged in the exhaust pipe in such a way of being lined up, in an axial direction of the exhaust pipe, from the exhaust gas inlet opening towards the exhaust gas outlet opening;
a wall-flow filter, which is arranged in the exhaust pipe at a location that is closest to the exhaust gas outlet opening; and
a flow guide tube, which comprises a plurality of second apertures, the flow guide tube being arranged outside the pipe wall of the exhaust pipe such that the second apertures respectively correspond to the first apertures, the flow guide tube being connected to a container that receives and holds therein urea liquid, the flow guide tube being provided, at a location thereof, with an electromagnetic valve, which controls passages of the urea liquid of the container through the second apertures and the first apertures to be absorbed by the ceramic fiber material and subsequently penetrating into pores of the direct-through ceramic filters and the wall-flow filter.

2. The drip-irrigation catalytic reduction exhaust pipe according to claim 1, wherein the wall-flow filter is alternatively replaced by a direct-through ceramic filters.

3. The drip-irrigation catalytic reduction exhaust pipe according to claim 1, wherein the direct-through ceramic filters and the wall-flow filter are arranged to separate from each other in the exhaust pipe.

4. The drip-irrigation catalytic reduction exhaust pipe according to claim 2, wherein the direct-through ceramic filters are arranged to separate from each other in the exhaust pipe.

5. The drip-irrigation catalytic reduction exhaust pipe according to claim 1, wherein the electromagnetic valve is electrically connected to an electrical power supply of an automobile such that when the electrical power supply of the automobile is activated, the electromagnetic valve is activated simultaneously and when the electrical power supply of the automobile is shut down, the electromagnetic valve is closed simultaneously.

6. The drip-irrigation catalytic reduction exhaust pipe according to claim 2, wherein the electromagnetic valve is electrically connected to an electrical power supply of an automobile such that when the electrical power supply of the automobile is activated, the electromagnetic valve is activated simultaneously and when the electrical power supply of the automobile is shut down, the electromagnetic valve is closed simultaneously.

7. The drip-irrigation catalytic reduction exhaust pipe according to claim 1, wherein the first apertures are arranged along a straight line in the axial direction of the exhaust pipe and the second apertures are arranged along a straight line in an axial direction of the flow guide tube.

8. The drip-irrigation catalytic reduction exhaust pipe according to claim 2, wherein the first apertures are arranged along a straight line in the axial direction of the exhaust pipe and the second apertures are arranged along a straight line in an axial direction of the flow guide tube.
